(19) United States
(12) Patent Application Publication
(10) Pub. No.: US 2001/0044879 A1
(43) Pub. Date: Nov. 22, 2001

(54) System and method for distributed management of data storage

(76) Inventors: Gregory Hagan Moulton, Irvine, CA (US); Scott Clifford Auchmoody, Irvine, CA (US); Felix Hamilton, Irvine, CA (US)

Correspondence Address: Stuart T. Langley, Esq., Hogan & Hartson, LLP, Suite 1500, 1200 17th Street, Denver, CO, 80202, US

(21) Appl. No.: 09/782,532

(22) Filed: Feb. 13, 2001

Related U.S. Application Data
(60) Provisional application No. 60/183,762, filed on Feb. 18, 2000.
(60) Provisional application No. 60/245,920, filed on Nov. 6, 2000.

(51) Int. Cl. G06F 12/00; G06F 13/28

(52) U.S. Cl. 711/114; 714/6; 709/213

(57) ABSTRACT

A data storage system including at least one network-accessible storage device capable of storing data. A plurality of network-accessible devices are configured to implement storage management processes. A communication system enables the storage management processes to communicate with each other. The storage management processes comprise processes for storing data on the at least one network-accessible device.

### CROSS REFERENCE TO RELATED PATENT APPLICATIONS

The present invention claims priority from U.S. Provisional Patent Application Ser. No. 60/183,762 for: “System and Method for Decentralized Data Storage” filed Feb. 18, 2000, and U.S. Provisional Patent Application Ser. No. 60/245,920 filed Nov. 6, 2000 entitled “System and Method for Decentralized Data Storage” the disclosures of which are herein specifically incorporated by this reference.

### BACKGROUND OF THE INVENTION

1. Field of the Invention

The present invention relates, in general, to network data storage, and, more particularly, to software, systems and methods for distributed allocation and management of a storage network infrastructure.

2. Relevant Background

Economic, political, and social power are increasingly managed by data. Transactions and wealth are represented by data. Political power is analyzed and modified based on data. Human interactions and relationships are defined by data exchanges. Hence, the efficient distribution, storage, and management of data is expected to play an increasingly vital role in human society.

The quantity of data that must be managed, in the form of computer programs, databases, files, and the like, increases exponentially. As computer processing power increases, operating system and application software becomes larger. Moreover, the desire to access larger data sets such as data sets comprising multimedia files and large databases further increases the quantity of data that is managed. This increasingly large data load must be transported between computing devices and stored in an accessible fashion. The exponential growth rate of data is expected to outpace improvements in communication bandwidth and storage capacity, making the need to handle data management tasks using conventional methods even more urgent.

Data comes in many varieties and flavors. Characteristics of data include, for example, the frequency of read access, frequency of write access, average size of each access request, permissible latency, permissible availability, desired reliability, security, and the like. Some data is accessed frequently, yet rarely changed. Other data is frequently changed and requires low latency access. These characteristics should affect the manner in which data is stored.

Many factors must be balanced and often compromised in the operation of conventional data storage systems. Because the quantity of data stored is large and rapidly increasing, there is continuing pressure to reduce cost per bit of storage. Also, data management systems should be sufficiently scaleable to contemplate not only current needs, but future needs as well. Preferably, storage systems are designed to be incrementally scaleable so that a user can purchase only the capacity needed at any particular time. High reliability and high availability are also considered desirable as data users become increasingly intolerant of lost, damaged, and unavailable data. Unfortunately, conventional data management architectures must compromise these factors—no single data architecture provides a cost-effective, highly reliable, highly available, and dynamically scaleable solution. Conventional RAID (redundant array of independent disks) systems provide a way to store the same data in different places (thus, redundantly) on multiple storage devices such as hard disks. By placing data on multiple disks, input/output (I/O) operations can overlap in a balanced way, improving performance. Since using multiple disks increases the mean time between failure (MTBF) for the system as a whole, storing data redundantly also increases fault-tolerance. A RAID system relies on a hardware or software controller to hide the complexities of the actual data management so that a RAID system appears to an operating system to be a single logical hard disk. However, RAID systems are difficult to scale because of physical limitations on the cabling and controllers. Also, RAID systems are highly dependent on the controllers so that when a controller fails, the data stored behind the controller becomes unavailable. Moreover, RAID systems require specialized, rather than commodity hardware, and so tend to be expensive solutions.

RAID solutions are also relatively expensive to maintain. RAID systems are designed to enable recreation of data on a failed disk or controller but the failed disk must be replaced to restore high availability and high reliability functionality. Until replacement occurs, the system is vulnerable to additional device failures. Condition of the system hardware must be continually monitored and maintenance performed as needed to maintain functionality. Hence, RAID systems must be physically situated so that they are accessible to trained technicians who can perform the maintenance. This limitation makes it difficult to set up a RAID system at a remote location or in a foreign country where suitable technicians would have to be found and/or transported to the RAID equipment to perform maintenance functions.

While RAID systems address the allocation and management of data within storage devices, other issues surround methods for connecting storage to computing platforms. Several methods exist including: Direct Attached Storage (DAS), Network Attached Storage (NAS), and Storage Area Networks (SAN). Currently, the vast majority of data storage devices such as disk drives, disk arrays and RAID systems are directly attached to a client computer through various adapters with standardized software protocols such as EIDE, SCSI, Fibre Channel and others.

NAS and SAN refer to data storage devices that are accessible through a network rather than being directly attached to a computing device. A client computer accesses the NAS/SAN through a network and requests are mapped to the NAS/SAN physical device or devices. NAS/SAN devices may perform I/O operations using RAID internally (i.e., within a NAS/SAN node). NAS/SAN may also automate mirroring of data to one or more other devices at the same node to further improve fault tolerance. Because NAS/SAN mechanisms allow for adding storage media within specified bounds and can be added to a network, they may enable some scaling of the capacity of the storage systems by adding additional nodes. However, NAS/SAN devices themselves implement DAS to access their storage media and so are constrained in RAID applications to the abilities of conventional RAID controllers. NAS/SAN systems do not enable mirroring and parity across nodes, and so a single point of failure at a typical NAS/SAN node makes all of the data stored at that node unavailable.

Because NAS and SAN solutions are highly dependent on network availability, the NAS devices are preferably implemented on high-speed, highly reliable networks using costly interconnect technology such as Fibre Channel. However, the most widely available and geographically distributed network, the Internet, is inherently unreliable and so has been viewed as a sub-optimal choice for NAS and SAN implementation. Hence, a need exists for a storage management system that enables a large number of unreliably connected, independent servers to function as a reliable whole.

In general, current storage methodologies have limited scalability and/or present too much complexity to devices that use the storage. Important functions of a storage management mechanism include communicating with physical storage devices, allocating and deallocating capacity within the physical storage devices, and managing read/write communication between the devices that use the storage and the physical storage devices. Storage management may also include more complex functionality including mirroring and parity operations.

In a conventional personal computer, for example, the storage subsystem comprises one or more hard disk drives and a disk controller comprising drive control logic for implementing an interface to the hard drives. In RAID systems, multiple hard disk drives are used, and the control logic implements the mirroring and parity operations that are characteristic of RAID mechanisms. The control logic implements the storage management functions and presents the user with an interface that preferably hides the complexity of the underlying physical storage devices and control logic.

As currently implemented, storage management functions are highly constrained by, for example, the physical limitations of the connections available between physical storage devices. These physical limitations regulate the number and diversity of physical storage devices that can be combined to implement particular storage needs. For example, a single RAID controller cannot manage and store a data set across different buildings because the controller cannot connect to storage devices that are separated by such distance. Similarly, a hard disk controller or RAID controller has a limited number of devices that it can connect to. What is needed is a storage management system that supports an arbitrarily large number of physical devices that may be separated from each other by arbitrarily large distances.

Another significant limitation of current storage management implementation is that the functionality is implemented in some centralized entity (e.g., the control logic), that receives requests from all users and implements the requests in the physical storage devices. Even where data is protected by mirroring or parity, failure of any portion of the centralized functionality affects availability of all data stored behind those devices.

Further, current storage management systems and methods are inherently static or are at best configurable within very limited bounds. A storage management system is configured at startup to provide a specified level of reliability, specified recovery rates, a specified and generally limited addressable storage capacity, and a restricted set of user devices from which storage tasks can be accepted. As needs change, however, it is often desirable to alter some or all of these characteristics. Even when the storage system can be reconfigured, such reconfiguration usually involves making the stored data unavailable for some time while new storage capacity is allocated and the data is migrated to the newly allocated storage capacity.

### SUMMARY OF THE INVENTION

Briefly stated, the present invention involves a data storage system that implements storage management functionality in a distributed manner. Preferably, the storage management system comprises a plurality of instances of storage management processes where the instances are physically distributed such that failure or unavailability of any given instance or set of instances will not impact the availability of stored data.

The storage management functions in combination with one or more networked devices that are capable of storing data to provide what is referred to herein as a “storage substrate”. The storage management process instances communicate with each other to store data in a distributed, collaborative fashion with no centralized control of the system.

In a particular implementation, the present invention involves systems and methods for distributing data with parity (e.g., redundancy) over a large geographic and topological area in a network architecture. Data is transported to, from, and between nodes using network connections rather than bus connections. The network data distribution relaxes or removes limitations on the number of storage devices and the maximum physical separation between storage devices that limited prior fault-tolerant data storage systems and methods. The present invention allows data storage to be distributed over larger areas (e.g., the entire world), thereby mitigating outages from localized problems such as network failures, power failures, as well as natural and man-made disasters.

### BRIEF DESCRIPTION OF THE DRAWINGS

FIG. 1 illustrates a globally distributed storage network in accordance with an embodiment of the present invention.

FIG. 2 shows a networked computer environment in which the present invention is implemented;

FIG. 3 illustrates components of a RAIN element in accordance with an embodiment of the present invention; and

FIG. 4 shows in block diagram form process relationships in a system in accordance with the present invention;

FIG. 5 illustrates in block diagram form functional entities and relationships in accordance with an embodiment of the present invention;

FIG. 6 shows an exemplary set of component processes within a storage allocation management process of the present invention; and

FIGS. 7A-7F illustrate an exemplary set of protection levels that can be provided in accordance with the systems and methods of the present invention.

### DETAILED DESCRIPTION OF THE PREFERRED EMBODIMENTS

The present invention is directed to a high availability, high reliability storage system that leverages rapid advances in commodity computing devices and the robust nature of internetwork technology such as the Internet. In general, the present invention involves a redundant array of inexpensive nodes (RAIN) distributed throughout a network topology. Nodes may be located on local area networks (LANs), metropolitan area network (MAN), wide area networks (WANs), or any other network having spatially distanced nodes. Nodes are preferably internetworked using mechanisms such as the Internet. In specific embodiments, at least some nodes are publicly accessible through public networks such as the Internet and the nodes communicate with each other by way of private networks and/or virtual private networks, which may themselves be implemented using Internet resources.

Significantly, the nodes implement not only storage, but sufficient intelligence to communicate with each other and manage not only their own storage, but storage on other nodes. For example, storage nodes maintain state information describing other storage nodes capabilities, connectivity, capacity, and the like. Also, storage nodes may be enabled to cause storage functions such as read/write functions to be performed on other storage nodes. Traditional storage systems do not allow peer-to-peer type information sharing amongst the storage devices themselves. In contrast, the present invention enables peer-to-peer information exchange and, as a result, implements a significantly more robust system that is highly scaleable. The system is scaleable because, among other reasons, many storage tasks can be implemented in parallel by multiple storage devices. The system is robust because the storage nodes can be globally distributed making the system immune to events in any one or more geographical, political, or network topological location.

The present invention is implemented in a globally distributed storage system involving storage nodes that are optionally managed by distributed storage allocation management (SAM) processes. The nodes are connected to a network and data is preferably distributed to the nodes in a multi-level, fault-tolerant fashion. In contrast to conventional RAID systems, the present invention enables mirroring, parity operations, and divided shared secrets to be spread across nodes rather than simply across hard drives within a single node. Nodes can be dynamically added to and removed from the system while the data managed by the system remains available. In this manner, the system of the present invention avoids single or multiple failure points in a manner that is orders of magnitude more robust than conventional RAID systems.

The present invention is illustrated and described in terms of a distributed computing environment such as an enterprise computing system using public communication channels such as the Internet. However, an important feature of the present invention is that it is readily scaled upwardly and downwardly to meet the needs of a particular application. Accordingly, unless specified to the contrary the present invention is applicable to significantly larger, more complex network environments as well as small network environments such as those typified by conventional LAN systems.

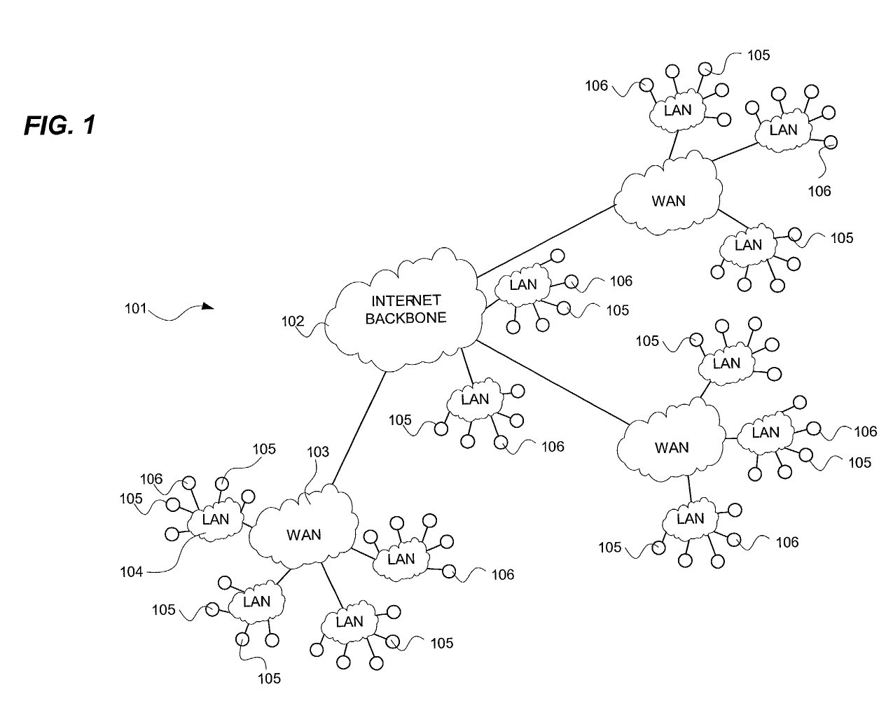

The present invention is directed to data storage on a network 101 shown in FIG. 1. FIG. 1 shows an exemplary internetwork environment 101 such as the Internet. The Internet is a global internetwork formed by logical and physical connections between multiple wide area networks (WANS) 103 and local area networks (LANs) 104. An Internet backbone 102 represents the main lines and routers that carry the bulk of the traffic. The backbone is formed by the largest networks in the system that are operated by major Internet Service Providers (ISPs) such as GTE, MCI, Sprint, UUNet, and America Online, for example. While single connection lines are used to conveniently illustrate WAN 103 and LAN 104 connections to the Internet backbone 102, it should be understood that in reality multi-path, routable wired and/or wireless connections exist between multiple WANs 103 and LANs 104. This makes internetwork 101 robust when faced with single or multiple failure points.

It is important to distinguish network connections from internal data pathways implemented between peripheral devices within a computer. A “network” comprises a system of general purpose, usually switched, physical connections that enable logical connections between processes operating on nodes 105. The physical connections implemented by a network are typically independent of the logical connections that are established between processes using the network. In this manner, a heterogeneous set of processes ranging from file transfer, mail transfer, and the like can use the same physical network. Conversely, the network can be formed from a heterogeneous set of physical network technologies that are invisible to the logically connected processes using the network. Because the logical connection between processes implemented by a network is independent of the physical connection, internetworks are readily scaled to a virtually unlimited number of nodes over long distances.

In contrast, internal data pathways such as a system bus, Peripheral Component Interconnect (PCI) bus, Intelligent Drive Electronics (IDE) bus, Small Computer System Interface (SCSI) bus, Fibre Channel, and the like define physical connections that implement special-purpose connections within a computer system. These connections implement physical connections between physical devices as opposed to logical connections between processes. These physical connections are characterized by limited distance between components, limited number of devices that can be coupled to the connection, and constrained format of devices that can communicate over the connection.

To generalize the above discussion, the term “network” as it is used herein refers to a means enabling a physical and logical connection between devices that 1) enables at least some of the devices to communicate with external sources, and 2) enables the devices to communicate with each other. It is contemplated that some of the internal data pathways described above could be modified to implement the peer-to-peer style communication of the present invention, however, such functionality is not currently available in commodity components. Moreover, such modification, while useful, would fail to realize the full potential of the present invention as storage nodes implemented across, for example, a SCSI bus would inherently lack the level of physical and topological diversity that can be achieved with the present invention.

Referring again to FIG. 1, the present invention is implemented by implementing a plurality of storage management mechanisms 106 controlling a plurality of storage devices at nodes 105. For ease of understanding, mechanisms 106 are illustrated as distinct entities from entities 105. In preferred implementations, however, storage nodes 105 and storage management mechanisms 106 are merged in the sense that both are implemented at each node 105/106. However, it is contemplated that they may be implemented in distinct network nodes as literally shown in FIG. 1.

The storage at any node 105 may comprise a single hard drive, may comprise a managed storage system such as a conventional RAID device having multiple hard drives configured as a single logical volume, or may comprise any reasonable hardware configuration spanned by these possibilities. Significantly, the present invention manages redundancy operations across nodes, as opposed to within nodes, so that the specific configuration of the storage within any given node can be varied significantly without departing from the present invention.

Optionally, one or more nodes such as nodes 106 implement storage allocation management (SAM) processes that manage data storage across multiple nodes 105 in a distributed, collaborative fashion. SAM processes may be implemented in a centralized fashion within special-purpose nodes 106. Alternatively, SAM processes are implemented within some or all of the RAIN nodes 105. The SAM processes communicate with each other and handle access to the actual storage devices within any particular RAIN node 105. The capabilities, distribution, and connections provided by the RAIN nodes 105 in accordance with the present invention enable storage processes (e.g., SAM processes) to operate with little or no centralized control for the system as whole.

In a particular implementation, SAM processes provide data distribution across nodes 105 and implement recovery in a fault-tolerant fashion across network nodes 105 in a manner similar to paradigms found in RAID storage subsystems However, because SAM processes operate across nodes rather than within a single node or within a single computer, they allow for greater levels of fault tolerance and storage efficiency than those that may be achieved using conventional RAID systems. Moreover, it is not simply that the SAM processes operate across network nodes, but also that SAM processes are themselves distributed in a highly parallel and redundant manner, especially when implemented within some or all of the nodes 105. By way of this distribution of functionality as well as data, failure of any node or group of nodes will be much less likely to affect the overall availability of stored data.

For example, SAM processes can recover even when a network node 105, LAN 104, or WAN 103 becomes unavailable. Moreover, even when a portion of the Internet backbone 102 becomes unavailable through failure or congestion the SAM processes can recover using data distributed on nodes 105 and functionality that is distributed on the various SAM nodes 106 that remain accessible. In this manner, the present invention leverages the robust nature of internetworks to provide unprecedented availability, reliability, and robustness.

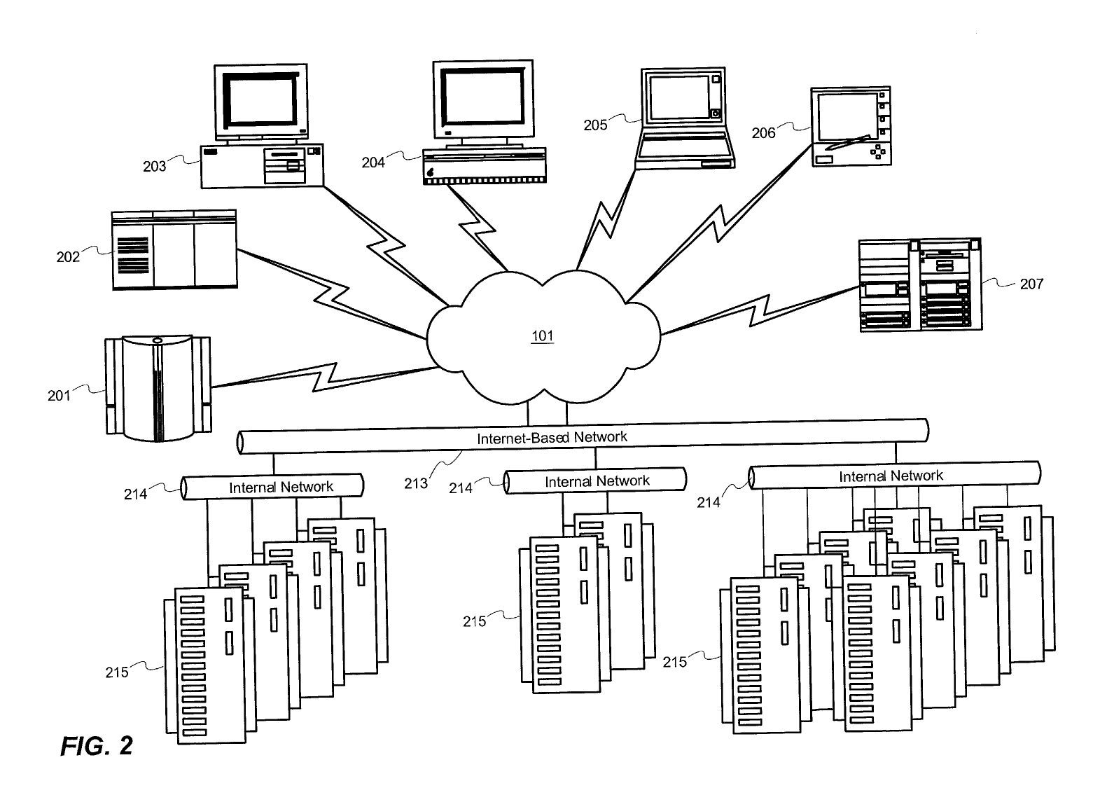

FIG. 2 shows an alternate view of an exemplary network computing environment in which the present invention is implemented. Internetwork 101 enables the interconnection of a heterogeneous set of computing devices and mechanisms ranging from a supercomputer or data center 201 to a hand-held or pen-based device 206. While such devices have disparate data storage needs, they share an ability to retrieve data via network 101 and operate on that data using their own resources. Disparate computing devices including mainframe computers (e.g., VAX station 202 and IBM AS/400 station 208) as well as personal computer or workstation class devices such as IBM compatible device 203, Macintosh device 204 and laptop computer 205 are easily interconnected via internetwork 101. The present invention also contemplates wireless device connections to devices such as cell phones, laptop computers, pagers, hand held computers, and the like.

Internet-based network 213 comprises a set of logical connections, some of which are made through internetwork 101, between a plurality of internal networks 214. Conceptually, Internet-based network 213 is akin to a WAN 103 in that it enables logical connections between spatially distant nodes. Internet-based networks 213 may be implemented using the Internet or other public and private WAN technologies including leased lines, Fibre Channel, frame relay, and the like.

Similarly, internal networks 214 are conceptually akin to LANs 104 shown in FIG. 1 in that they enable logical connections across more limited distances than those allowed by a WAN 103. Internal networks 214 may be implemented using LAN technologies including Ethernet, Fiber Distributed Data Interface (FDDI), Token Ring, AppleTalk, Fibre Channel, and the like.

Each internal network 214 connects one or more RAIN elements 215 to implement RAIN nodes 105. RAIN elements 215 illustrate an exemplary instance of hardware/software platform that implements a RAIN node 105. Conversely, a RAIN node 105 refers to a more abstract logical entity that illustrates the presence of the RAIN functionality to external network users. Each RAIN element 215 comprises a processor, memory, and one or more mass storage devices such as hard disks. RAIN elements 215 also include hard disk controllers that may be conventional EIDE or SCSI controllers, or may be managing controllers such as RAID controllers. RAIN elements 215 may be physically dispersed or co-located in one or more racks sharing resources such as cooling and power. Each node 105 is independent of other nodes 105 in that failure or unavailability of one node 105 does not affect availability of other nodes 105, and data stored on one node 105 may be reconstructed from data stored on other nodes 105.

The perspective provided by FIG. 2 is highly physical and it should be kept in mind that physical implementation of the present invention may take a variety of forms. The multi-tiered network structure of FIG. 2 may be altered to a single tier in which all RAIN nodes 105 communicate directly with the Internet. Alternatively, three or more network tiers may be present with RAIN nodes 105 clustered behind any given tier. A significant feature of the present invention is that it is readily adaptable to these heterogeneous implementations.

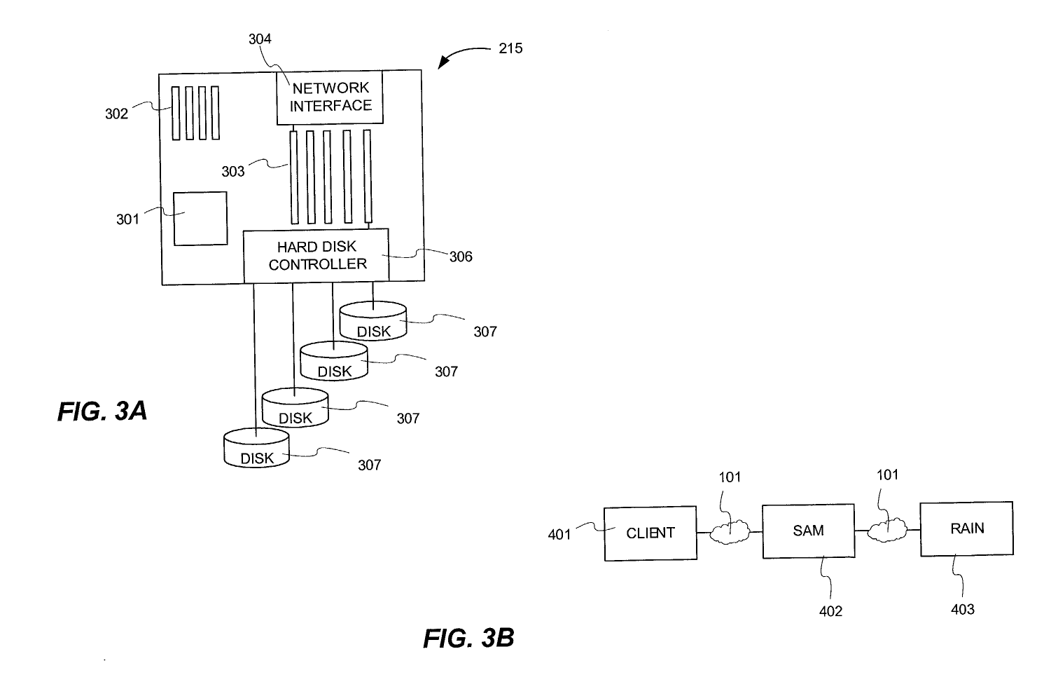

RAIN elements 215 are shown in greater detail in FIG. 3. In a particular implementation, RAIN elements 215 comprise computers using commodity components such as Intel-based microprocessors 301 mounted on a motherboard supporting a PCI bus 303 and 128 megabytes of random access memory (RAM) 302 housed in a conventional AT or ATX case. SCSI or IDE controllers 306 may be implemented on the motherboard and/or by expansion cards connected to the PCI bus 303. Where the controllers 306 are implemented only on the motherboard, a PCI expansion bus 303 is optional. In a particular implementation, the motherboard implements two mastering EIDE channels and an PCI expansion card is used to implement two additional mastering EIDE channels so that each RAIN element 215 includes up to four EIDE hard disks 307, each with a dedicated EIDE channel. In the particular implementation, each hard disk 307 comprises an 80 gigabyte hard disk for a total storage capacity of 320 gigabytes per RAIN element 215. The casing also houses supporting mechanisms such as power supplies and cooling devices (not shown).

The specific implementation discussed above is readily modified to meet the needs of a particular application. Because the present invention uses network methods to communicate with the storage nodes, the particular implementation of the storage node is largely hidden from the devices using the storage nodes, making the present invention uniquely receptive to modification of node configuration and highly tolerant of systems comprised by heterogeneous storage node configurations. For example, processor type, speed, instruction set architecture, and the like can be modified and may vary from node to node. The hard disk capacity and configuration within RAIN elements 215 can be readily increased or decreased to meet the needs of a particular application. Although mass storage is implemented using magnetic hard disks, other types of mass storage devices such as magneto-optical, optical disk, digital optical tape, holographic storage, atomic force probe storage and the like can be used as suitable equivalents as they become increasingly available. Memory configurations including RAM capacity, RAM speed, RAM type (e.g., DRAM, SRAM, SDRAM) can vary from node to node making the present invention incrementally upgradeable to take advantage of new technologies and component pricing. Network interface components may be provided in the form of expansion cards coupled to a mother board or built into a mother board and may operate with a variety of available interface speeds (e.g., 10 BaseT Ethernet, 100 BaseT Ethernet, Gigabit Ethernet, 56K analog modem) and can provide varying levels of buffering, protocol stack processing, and the like.

RAIN elements 215 desirably implement a “heartbeat” process that informs other RAIN nodes or storage management processes of their existence and their state of operation. For example, when a RAIN node 105 is attached to a network 213 or 214, the heartbeat message indicates that the RAIN element 215 is available, and notifies of its available storage. The RAIN element 215 can report disk failures that require parity operations. Loss of the heartbeat for a predetermined length of time may result in reconstruction of an entire node at an alternate node or in a preferable implementation, the data on the lost node is reconstructed on a plurality of pre-existing nodes elsewhere in the system. In a particular implementation, the heartbeat message is unicast to a single management node, or multicast or broadcast to a plurality of management nodes periodically or intermittently. The broadcast may be scheduled at regular or irregular intervals, or may occur on a pseudorandom schedule. The heartbeat message includes information such as the network address of the associated RAIN node 105, storage capacity, state information, maintenance information and the like.

Specifically, it is contemplated that the processing power, memory, network connectivity and other features of the implementation shown in FIG. 3 could be integrated within a disk drive controller and actually integrated within the housing of a disk drive itself. In such a configuration, a RAIN element 215 might be deployed simply by connecting such an integrated device to an available network, and multiple RAIN elements 215 might be housed in a single physical enclosure.

Each RAIN element 215 may execute an operating system. The particular implementations use a UNIX operating system (OS) or UNIX-variant OS such as Linux. It is contemplated, however, that other operating systems including DOS, Microsoft Windows, Apple Macintosh OS, OS/2, Microsoft Windows NT and the like may be equivalently substituted with predictable changes in performance. Moreover, special purpose lightweight operating systems or micro kernels may also be used, although the cost of development of such operating systems may be prohibitive. The operating system chosen implements a platform for executing application software and processes, mechanisms for accessing a network, and mechanisms for accessing mass storage. Optionally, the OS supports a storage allocation system for the mass storage via the hard disk controller(s).

Various application software and processes can be implemented on each RAIN element 215 to provide network connectivity via a network interface 304 using appropriate network protocols such as User Datagram Protocol (UDP), Transmission Control Protocol (TCP), Internet Protocol (IP), Token Ring, Asynchronous Transfer Mode (ATM), and the like.

In the particular embodiments, the data stored in any particular node 105 can be recovered using data at one or more other nodes 105 using data recovery and storage management processes. These data recovery and storage management processes preferably execute on a node 106 and/or on one or more of the nodes 105 separate from the particular node 105 upon which the data is stored. Conceptually, storage management is provided across an arbitrary set of nodes 105 that may be coupled to separate, independent internal networks 215 via internetwork 213. This increases availability and reliability in that one or more internal networks 214 can fail or become unavailable due to congestion or other events without affecting the overall availability of data.

In an elemental form, each RAIN element 215 has some superficial similarity to a network attached storage (NAS) device. However, because the RAIN elements 215 work cooperatively, the functionality of a RAIN system comprising multiple cooperating RAIN elements 215 is significantly greater than a conventional NAS device. Further, each RAIN element preferably supports data structures that enable parity operations across nodes 105 (as opposed to within nodes 105). These data structures enable operation akin to RAID operation, however, because the RAIN operations are distributed across nodes and the nodes are logically, but not necessarily physically connected, the RAIN operations are significantly more fault tolerant and reliable than conventional RAID systems.

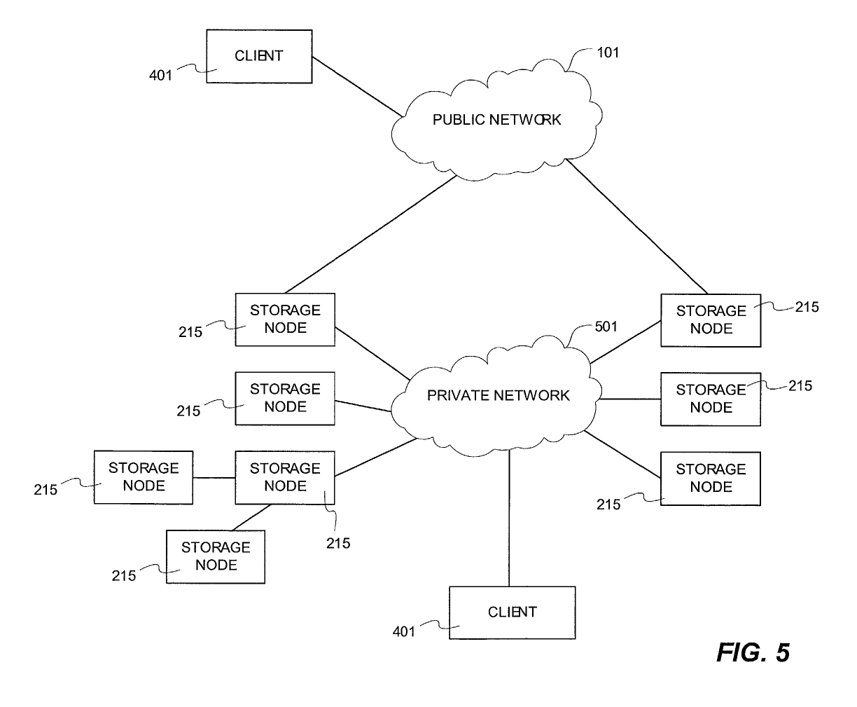

FIG. 4 shows a conceptual diagram of the relationship between the distributed storage management processes in accordance with the present invention. SAM processes 406 represent a collection of distributed instances of SAM processes 106 referenced in FIG. 1. Similarly, RAIN 405 in FIG. 5 represents a collection of instances of RAIN nodes 105 referenced in FIG. 1. It should be understood that RAIN instances 405 and SAM instances 406 are preferably distributed processes. In other words, the physical machines that implement these processes may comprise tens, hundreds, or thousands of machines that communicate with each other directly or via network(s) 101 to perform storage tasks.

A collection of RAIN storage element 405 provide basic persistent data storage functions by accepting read/write commands from external sources. Additionally, RAIN storage elements 405 communicate with each other to exchange state information that describes, for example, the particular context of each RAIN element 215 and/or RAIN node 105 within the collection 405.

A collection of SAM processes 406 provide basic storage management functions using the collection of RAIN storage nodes 405. The collection of SAM processes 406 are implemented in a distributed fashion across multiple nodes 105/106. SAM processes 406 receive storage access requests, and generate corresponding read/write commands to instances (i.e., members) of the RAIN node collection 405. SAM processes 406 are, in particular implementations, akin to RAID processes in that they select particular RAIN elements 215 to provide a desired level of availability/reliability using parity storage schemes. The SAM processes 406 are coupled to receive storage tasks from clients 401. Storage tasks may involve storage allocation, deallocation, migration, as well as read/write/parity operations. Storage tasks may associated with a specification of desired reliability rates, recovery rates, and the like.

FIG. 5 shows an exemplary storage system in accordance with the present invention from another perspective. Client 503 represents any of a number of network appliances that may use the storage system in accordance with the present invention. Client 503 uses a file system or other means for generating storage requests directed to one of accessible storage nodes 215. Not all storage nodes 215 need to be accessible through Internet 101. In one implementation, client 503 makes a storage request to a domain name using HyperText Transport Protocol (HTTP), Secure HyperText Transport Protocol (HTTPS), File Transfer Protocol (FTP), or the like. The Internet Domain Name System (DNS) will resolve the storage request to a particular IP address identifying a specific storage node 215 that implements the SAM processes 401. Client 503 then directs the actual storage request using a mutual protocol to the identified IP address.

The storage request is directed using network routing resources to a storage node 215 assigned to the IP address. This storage node then conducts storage operations (i.e., data read and write transactions) on mass storage devices implemented in the storage node 215, or on any other storage node 215 that can be reached over an explicit or virtual private network 501. Some storage nodes 215 may be clustered as shown in the lower left side of FIG. 5., and clustered storage nodes may be accessible through another storage node 215.

Preferably, all storage nodes are enabled to exchange state information via private network 501. Private network 501 is implemented as a virtual private network over Internet 101 in the particular examples. In the particular examples, each storage node 215 can send and receive state information. However, it is contemplated that in some applications some storage nodes 215 may need only to send their state information while other nodes 215 act to send and receive storage information. The system state information may be exchanged universally such that all storage nodes 215 contain a consistent set of state information about all other storage nodes 215. Alternatively, some or all storage nodes 215 may only have information about a subset of storage nodes 215.

Another feature of the present invention involves the installation and maintenance of RAIN systems such as that shown in FIG. 5. Unlike conventional RAID systems, a RAIN system enables data to be cast out over multiple, geographically diverse nodes. RAIN elements and systems will often be located at great distances from the technical resources needed to perform maintenance such as replacing failed controllers or disks. While the commodity hardware and software at any particular RAIN node 105 is highly reliable, it is contemplated that failures will occur.

Using appropriate data protections, data is spread across multiple RAIN nodes 105 and/or multiple RAIN systems as described above. In event of a failure of one RAIN element 215, RAIN node 105, or RAIN system, high availability and high reliability functionality can be restored by accessing an alternate RAIN node 105 or RAIN system. At one level, this reduces the criticality of a failure so that it can be addressed days, weeks, or months after the failure without affecting system performance. At another level, it is contemplated that failures may never need to be addressed. In other words, a failed disk might never be used or repaired. This eliminates the need to deploy technical resources to distant locations. In theory, a RAIN node 105 can be set up and allowed to run for its entire lifetime without maintenance.

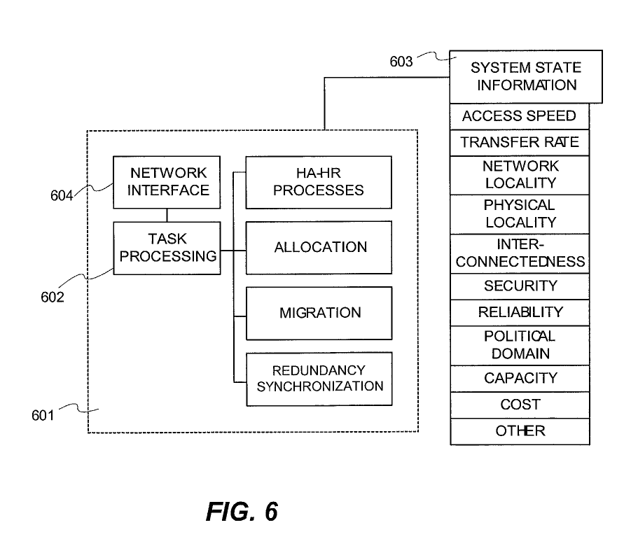

FIG. 6 illustrates an exemplary storage allocation management system including an instance 601 of SAM processes that provides an exemplary mechanism for managing storage held in RAIN nodes 105. SAM processes 601 may vary in complexity and implementation to meet the needs of a particular application. Also, it is not necessary that all instances 601 be identical, so long as they share a common protocol to enable interprocess communication. SAM processes instance 601 may vary in complexity from relatively simple file system-type processes to more complex redundant array storage processes involving multiple RAIN nodes 105. SAM processes may be implemented within a storage-using client, within a separate network node 106, or within some or all of RAIN nodes 105. In a basic form, SAM processes 601 implements a network interface 604 to communicate with, for example, network 101, processes to exchange state information with other instances 601, and store the state information in a state information data structure 603 and to read and write data to storage nodes 105. These basic functions enable a plurality of storage nodes 105 to coordinate their actions to implement a virtual storage substrate layer upon which more complex SAM processes 601 can be implemented.

In a more complex form, contemplated SAM processes 601 comprise a plurality of SAM processes that provide a set of functions for managing storage held in multiple RAIN nodes 105 and are used to coordinate, facilitate, and manage participating nodes 105 in a collective manner. In this manner, SAM processes 601 may realize benefits in the form of greater access speeds, distributed high speed data processing, increased security, greater storage capacity, lower storage cost, increased reliability and availability, decreased administrative costs, and the like.

In the particular example of FIG. 6, SAM processes are conveniently implemented as network-connected servers that receive storage requests from a network-attached file system. Network interface processes 604 may implement a first interface for receiving storage requests from a public network such as the Internet. In addition, network interface may implement a second interface for communicating with other storage nodes 105. The second interface may be, for example, a virtual private network. For convenience, a server implementing SAM processes is referred to as a SAM node 106, however, it should be understood from the above discussion that a SAM node 106 may in actuality be physically implemented on the same machine as a client 201 or RAIN node 105. An initial request can be directed at any server implementing SAM processes 601, or the file system may be reconfigured to direct the access request at a particular SAM node 106. When the initial server does not does not respond, the access request is desirably redirected to one or more alternative SAM nodes 106 and/or RAIN nodes 105 implementing SAM processes 601.

Storage request processing involves implementation of an interface or protocol that is used for requesting services or servicing requests between nodes or between SAM process instances 601 and clients of SAM processes. This protocol can be between SAM processes executing on a single node, but is more commonly between nodes running over a network, typically the Internet. Requests indicate, for example, the type and size of data to be stored, characteristic frequency of read and write access, constraints of physical or topological locality, cost constraints, and similar data that taken together characterize desired data storage characteristics.

Storage tasks are handled by storage task processing processes 602 which operate to generate read/write commands in view of system state information 603. Processes 602 include processing requests for storage access, identification and allocation/de-allocation of storage capacity, migration of data between storage nodes 105, redundancy synchronization between redundant data copies, and the like. SAM processes 601 preferably abstract or hide the underlying configuration, location, cost, and other context information of each RAIN node 105 from data users. SAM processes 601 also enable a degree of fault tolerance that is greater than any storage node in isolation as parity is spread out in a configurable manner across multiple storage nodes that are geographically, politically, and network topologically dispersed.

In one embodiment, the SAM processes 601 define multiple levels of RAID-like fault tolerant performance across nodes 105 in addition to fault tolerate functionality within nodes, including:

Level 0 RAIN, where data is striped across multiple nodes, without redundancy;

Level 1 RAIN, where data is mirrored between or among nodes;

Level 2 RAIN, where parity data for the system is stored in a single node.

Level 3 RAIN, where parity data for the system is distributed across multiple nodes;

Level 4 RAIN, where parity is distributed across multiple RAIN systems and where parity data is mirrored between systems;

Level 5 RAIN, where parity is distributed across multiple RAIN systems and where parity data for the multiple systems stored in a single RAIN system; and

Level 6 RAIN, where parity is distributed across multiple RAIN systems and where parity data is distributed across all systems.

Level (−1) RAIN, where data is only entered into the system as N separated secrets, where access to k (k<=N) are required to retrieve the data. In this manner, the data set to be stored only exists in a distributed form. Such distribution affects security in that a malicious party taking physical control of one or more of the nodes cannot access the data stored therein without access to all nodes that hold the threshold number of separated shared secrets. Such an implementation diverges from conventional RAID technology because level (−1) RAIN operation only makes sense in a geographically distributed parity system such as the present invention.

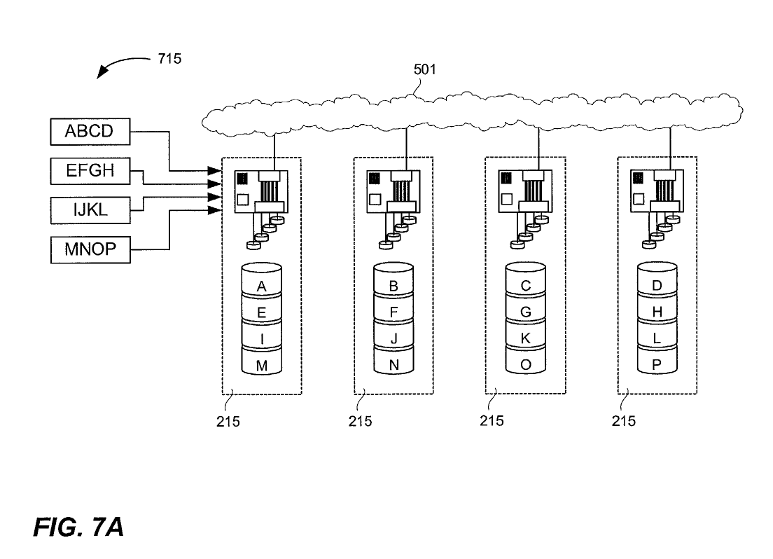

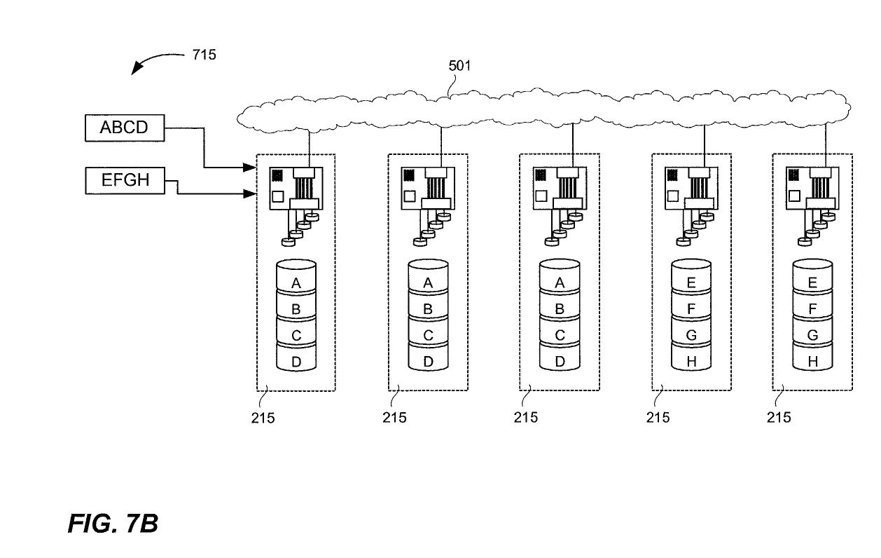

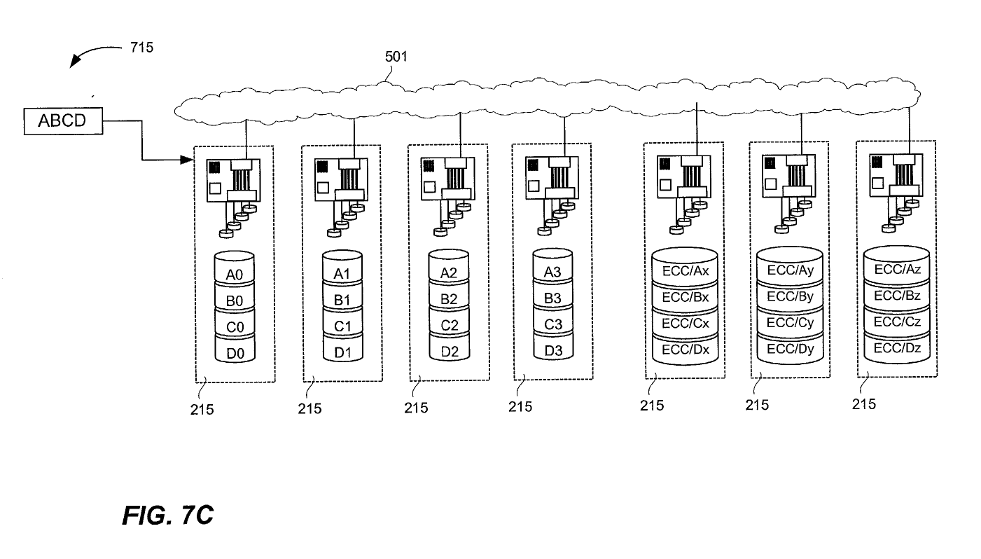

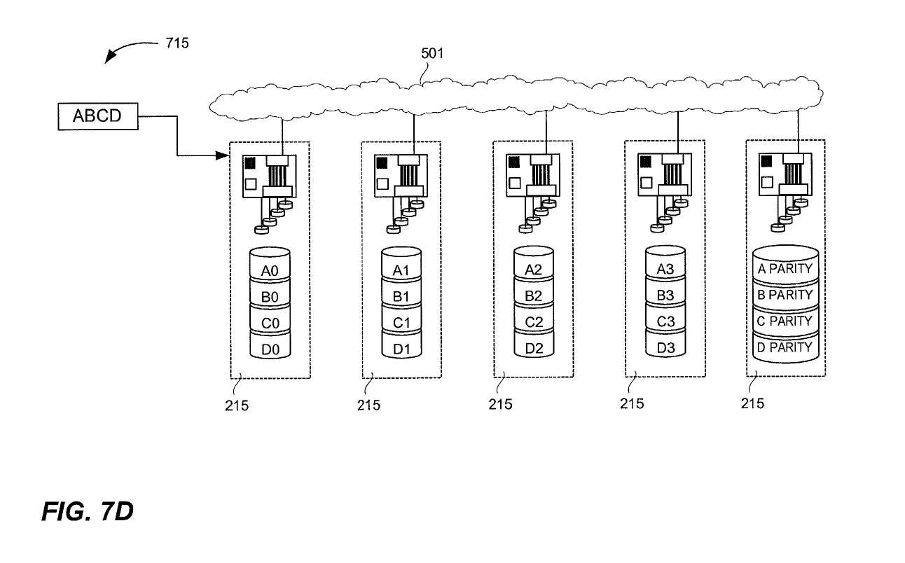

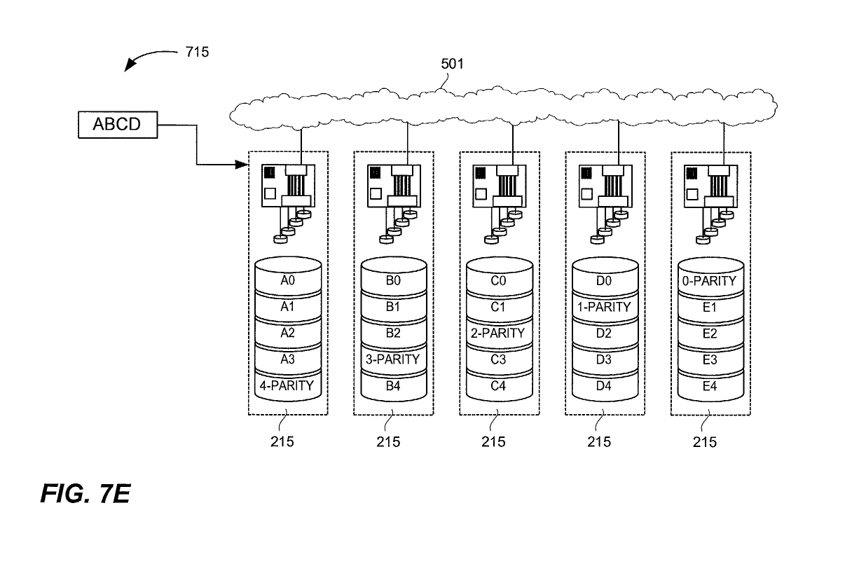

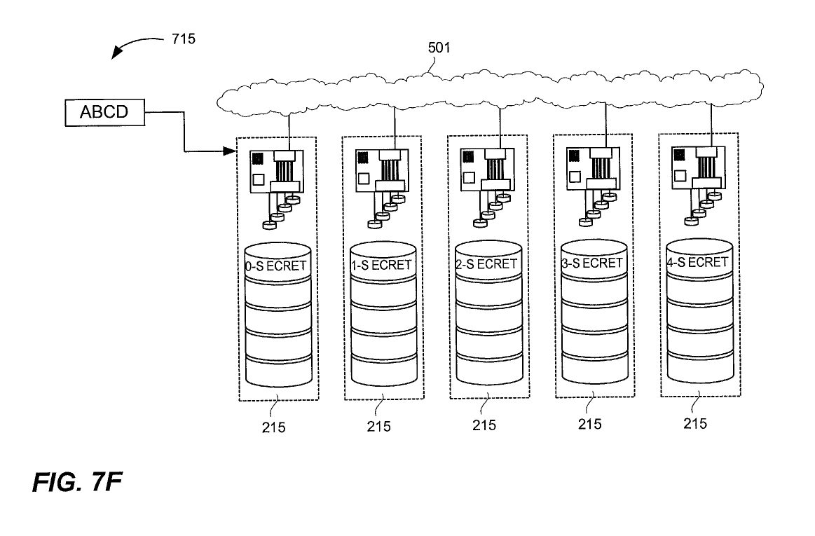

FIG. 7A-FIG. 7F illustrate various rain protection levels. In these examples, SAM processes 601 are implemented in each of the RAIN elements 215 and all requests 715 are first received by the SAM processes 601 in the left-most RAIN element 215. Any and all nodes 215 that implement instances 601 of the SAM processes may be configured to receive requests 715. The requests 715 are received over the Internet, for example. Nodes 215 may be in a single rack, single data center, or may be separated by thousands of miles.

FIG. 7A shows, for example, a RAIN level 0 implementation that provides striping without parity. Striping involves a process of dividing a body of data into blocks and spreading the data blocks across several independent storage mechanisms (i.e., RAIN nodes). Data 715, such as data element “ABCD”, is broken down into blocks “A”, “B”, “C” and “D” and each block is stored to separate disk drives. In such a system, I/O speed may be improved because read/write operations involving a chunk of data “ABCD” for example, are spread out amongst multiple channels and drives. Each RAIN element 215 can operate in parallel to perform the physical storage functions. RAIN Level 0 does not implement any means to protect data using parity, however.

As shown in FIG. 7B, a level 1 RAIN involves mirroring of each data element (e.g., elements A, B, C, and D in FIG. 4) to an independent RAIN element 215. In operation, every data write operation is executed to the primary node and all mirror nodes. Read operations attempt to first read the data from one of the nodes, and if that node is unavailable, a read from the mirror node is attempted. Mirroring is a relatively expensive process in that all data write operations on the primary image must be performed for each mirror, and the data consumes multiple times the disk space that would otherwise be required. However, Level1 RAIN offers high reliability and potentially faster access. Conventional mirroring systems cannot be configured to provide an arbitrarily large and dynamically configurable number of mirrors. In accordance with the present invention, multi-dimensional mirroring can be performed using two or more mirrors, and the number of mirrors can be changed at any time by the SAM processes. Each mirror further improves the system reliability. In addition, read operations can read different portions of the requested data from each available mirror, with the requested data being reconstructed at the point from which it was requested to satisfy the read request. This allows a configurable and extensible means to improve system read performance.

FIG. 7C shows a Level 2 RAIN system in which data is striped across multiple nodes and an error correcting code (ECC) is used to protect against failure of one or more of the devices. In the example of FIG. 7C, data element A is broken into multiple stripes (e.g., stripes A0 and A1 in FIG. 7B) and each stripe is written to an independent node. In a particular example, four stripes and hence four independent nodes 105 are used, although any number of stripes may be used to meet the needs of a particular application.

Striping offers a speed advantage in that smaller writes to multiple nodes can often be accomplished in parallel faster than a larger write to a single node. Level 2 RAIN is more efficient in terms of disk space and write speed than is a level 1 RAIN implementation, and provides data protection in that data from an unavailable node can be reconstructed from the ECC data. However, level 2 RAIN requires the computation and storage of ECC information (e.g., ECC/Ax-ECC/Az in FIG. 7C) corresponding to the data element (A) for every write. The ECC information is used to reconstruct data from one or more failed or otherwise unavailable nodes. The ECC information is stored on an independent element 215, and so can be accessed even when one of the other nodes 215 becomes unavailable.

FIG. 7D illustrates RAIN Level 3/4 configuration in which data is striped, and parity information is used to protect the data rather than ECC. Level 4 RAIN differs from Level 3 RAIN essentially in that Level 4 RAIN sizes each stripe to hold a complete block of data such that the data block (i.e., the typical size of I/O data) does not have to be subdivided. SAM processes 601 provide for parity generation, typically by performing an exclusive-or (XOR) operation on data as it is added to a stripe and the results of the XOR operation stored in the parity stripe—although other digital operations like addition and subtraction can also be used to generate this desired parity information.

The construction of parity stripes is a relatively expensive process in terms of network bandwidth. Each parity stripe is typically computed from a complete copy of its corresponding stripes. The parity stripe is computed by, for example, computing an exclusive or (XOR) value of each of the corresponding stripes (e.g., A0 and A1 in FIG. 7D). The set of corresponding data stripes that have been XORed into a parity stripe represents a “parity group”. Each parity stripe has a length counter for each data stripe it contains. As each stripe arrives to be XORed into the parity stripe, these length counters are incremented. If data arrives out of order, parity operations are preferably buffered until they can be ordered. The length of a parity stripe is the length of the longest corresponding data stripe.

A data stripe can be added or removed at any time from a parity stripe. Thus parity groups in an operational system can increase or decrease in size to an arbitrary and configurable extent. Subtracting a data stripe uses the same XOR operations as adding a parity stripe. An arbitrary number of data stripes can be XORed into a parity stripe, although reconstruction becomes more complex and expensive as the parity group grows in size. A parity stripe containing only one data stripe is in effect a mirror (i.e., an exact copy) of the data stripe. This means that mirroring, as in level-1 RAIN) is implemented by simply setting the parity group size to one data member.

FIG. 7E illustrates RAIN level 5 operation in which parity information is striped across multiple elements 215 rather than being stored on a single element 215 as shown in FIG. 7E. This configuration provides a high read rate, and a low ratio of parity space to data space. However, a node failure has an impact on recovery rate as both the data and the parity information must be recovered, and typically must be recovered over the network. Unlike conventional RAID level 5 mechanisms, however, the processes involved in reconstruction can be implemented in parallel across multiple instances of SAM processes 601 making RAIN Level 5 operation efficient.

FIG. 7F illustrates an exemplary level (−1) RAIN protection system which involves the division and storage of a data set in a manner that provides unprecedented security levels. Preferably the primary data set is divided into n pieces labeled “0-SECRET” through “4-SECRET” in FIG. 7F. This information is striped across multiple drives and may itself be protected by mirroring and/or parity so that failure of one device does not affect availability of the underlying data. This level of operation is especially useful in geographically distributed nodes because control over any one node, or anything less than all of the nodes will not make a portion of the data available.

In the example of FIG. 7F, the division and generation of the “0-SECRET” through “4-SECRET” components of a primary data set “ABCD” is determined such that any number k of them are sufficient to reconstruct the original data, but that k−1 pieces give no information whatsoever about the primary data set. This is an algorithmic scheme called divided shared secrets. While such schemes are used in message cryptography, they have been viewed as too complex for data security for data storage. Hence, neither this scheme or any other for increasing the security of data has been used in a data storage parity implementation such as this.

For purposes of this disclosure, a “RAIN system” is a set of RAIN elements that are assigned to or related to a particular data set. A RAIN system is desirably presented to users as a single logical entity (e.g., as a single NAS unit or logical volume) from the perspective of devices using the RAIN system. Unlike RAID solutions, multiple RAIN systems can be enabled and the ability to distribute parity information across systems is almost as easy as distribution across a single system. However, spreading parity across multiple systems increases the fault tolerance significantly as the failure of an entire, distributed RAIN system can be tolerated without data loss or unavailability.

By way of comparison, conventional RAID systems are significantly limited by the number of devices that can be managed by any one RAID controller, cable lengths, and the total storage capacity of each disk drive in the RAID system. In contrast, the RAIN system in accordance with the present invention can take advantage of an almost limitless quantity of data storage in a variety of locations and configurations. Hence, where practical limitations may prohibit a RAID system from keeping multiple mirrors, or multiple copies of parity data, the RAIN system in accordance with the present invention has no such limitations. Accordingly, parity information may be maintained in the same system as the data stripes, or on an independent RAIN system, or both. By increasing the number of copies and the degree of redundancy in the storage, the RAIN system in accordance with the present invention is contemplated to achieve unprecedented levels of data availability and reliability.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A data storage management system comprising:
at least one network-accessible storage device capable of storing data;
a plurality of network-accessible devices configured to implement storage management processes;
a communication system enabling the storage management processes to communicate with each other; and
wherein the storage management processes comprise processes for storing data to the at least one network-accessible device.

2. The data storage management system of claim 1 wherein the at least one network-accessible device capable of storing data comprises a plurality of network-accessible devices capable of storing data, some of which are located at distinct network nodes.

3. The data storage system of claim 1 wherein the storage management processes comprise processes for serving data from the at least one network accessible storage device.

4. The data storage system of claim 1 wherein the at least one storage device comprises a RAID storage system.

5. The data storage system of claim 1 wherein the at least one storage device comprises a computer with direct attached storage (DAS) selected from the group consisting of magnetic hard disk, magneto-optical, optical disk, digital optical tape, holographic storage, quantum storage, and atomic force probe storage.

6. The data storage system of claim 2 wherein the plurality of storage devices comprises a peer-to-peer network of storage devices, each storage device having means for communicating state information with other storage devices, at least one storage device comprising means for receiving storage requests from external entities, and at least one storage device comprising means for causing read and write operations to be performed on others of the storage devices.

7. The data storage system of claim 1 wherein the communication system comprises a TCP/IP over Ethernet network.

8. The data storage system of claim 1 wherein the communication system comprises Gigabit Ethernet network.

9. The data storage system of claim 1 wherein the communication system comprises a Fibre Channel fabric.

10. The data storage system of claim 1 wherein the communication system comprises a wireless network.

11. The data storage system of claim 2 wherein the processes for storing data comprise processes that implement a RAID-type distribution across the plurality of network-accessible devices.

12. The data storage system of claim 2 wherein the processes for storing data comprise processes that implement an n-dimensional parity scheme across the plurality of network accessible devices.

13. The data storage system of claim 12 wherein the processes for storing parity data expand or contract the size of the parity group associated with each data element to whatever extent is desired.

14. The data storage system of claim 12 wherein the storage management processes further comprise processes for recovery of data when one or more of the network-accessible storage devices is unavailable.

15. The data storage system of claim 12 wherein the storage management processes further comprise processes for access to stored data when one or more of the network accessible storage devices are not desirable data sources for reasons including but not limited to efficiency, performance, network congestion, and security.

16. The data storage system of claim 1 wherein the plurality of network-accessible devices configured to implement storage management processes further comprise commercial off-the-shelf computer systems implementing a common operating system.

17. The data storage system of claim 1 wherein the plurality of network-accessible devices configured to implement storage management processes further comprise commercial off-the-shelf computer systems implementing a heterogeneous set of operating systems.

18. The data storage system of claim 1 wherein the storage management processes comprise processes for implementing greater than two dimensions of parity.

19. The data storage system of claim 2 wherein the processes for storing data comprise processes that store parity and/or mirror data across more than one of the plurality of network-accessible storage devices.

20. The data storage system of claim 1 wherein the storage management processes comprise processes for adding and removing additional storage capacity to individual storage devices and the system as a whole.

21. A method of data storage management comprising the acts of:
providing at least one network-accessible storage device capable of storing data;
implementing a plurality of storage management process instances;
communicating storage messages between the storage management process instances; and
storing data to the at least one network-accessible device under control of at least one instance of the storage management processes.

22. The method of claim 21 wherein the at least one network-accessible device capable of storing data comprises a plurality of network-accessible storage devices capable of storing data, some of which are located at distinct network nodes.

23. The method of claim 21 further comprising serving data from the at least one network accessible storage device.

24. The method of claim 21 wherein the step of storing data to the at least one storage device comprises storing the data in a RAID-like fashion.

25. The method of claim 22 further comprising implementing a peer-to-peer network between the plurality of storage devices; and
communicating state information between the plurality of storage devices; and
performing read and write operations using the plurality of storage devices.

26. The method of claim 22 wherein the step of storing data comprises storing data using a RAID-type distribution across the plurality of network-accessible storage devices.

27. The method of claim 22 wherein the act of storing data comprises storing parity and/or mirror data across more than one of the plurality of network-accessible storage devices.

28. The method of claim 22 wherein the storage management process instances further comprise processes for recovery of data when one or more of the network-accessible storage devices is unavailable.

29. A data storage management system comprising:
a plurality of network-accessible storage devices capable of storing data;
a plurality of network-accessible devices configured to implement storage management processes;
a communication system enabling the storage management processes to communicate with each other;
wherein the storage management processes comprise processes for storing data to the at least one network-accessible storage device; and
wherein the at least one network-accessible device capable of storing data comprises a parity record holding parity information for at least one other storage node.

30. The data storage system of claim 29 wherein the parity record comprises data capable of correcting errors on another network-accessible storage device.

31. The data storage system of claim 29 wherein the parity record is stored in data structures on at least two network-accessible storage devices.

32. The data storage system of claim 29 wherein the data storage system comprises data structures implementing parity with one or more other, external data storage systems.

33. A method of data storage management comprising the acts of:
providing a plurality of network-accessible storage devices each capable of storing data;
implementing a plurality of storage management process instances;
communicating storage messages between the storage management process instances; and
identifying one or more storage devices associated with the data to be stored;
determining parity information for the data to be stored; and
storing the unit of data and/or parity data across the two or more storage devices.

34. The method of claim 33 wherein the parity data comprises an error checking and correcting code.

35. The method of claim 33 wherein the parity data comprises a mirror copy of the unit of data to be stored.

36. The method of claim 33 wherein the parity data is stored in a single network storage node and the unit of data is stored in two or more network storage nodes.

37. The method of claim 33 wherein the parity data is distributed across multiple storage nodes.

38. The method of claim 33 further comprising:
retrieving the stored unit of data;
verifying the correctness of the stored unit of data using the parity data;
upon detection of an error in the retrieved unit of data, retrieving the correct unit of data using the parity data.

39. The method of claim 33 further comprising:
attempting to retrieving the stored unit of data;
detecting unavailability of one of the two or more network storage nodes; and
in response to detecting unavailability, reconstructing the correct unit of data using the parity data.

40. The system of claim 33 wherein the act of storing the unit of data comprises distributing non-identical but logically equivalent data in a storage node.

41. The system of claim 33 further comprises storing lossy equivalent data in a storage node.

42. A method of data storage management comprising the acts of :
providing a plurality of network accessible storage devices capable of storing data;
implementing a plurality of storage management process instances;
communicating storage messages between the plurality of storage management processes;
storing data to the plurality of network accessible storage devices under control of the plurality of storage management processes; and
adding and subtracting data storage capacity to and from the data storage under control of the plurality of storage management processes without affecting accessibility of the data storage.

43. The method of claim 42 further comprising:
monitoring the data storage for faults by means of the plurality of storage management processes;
compensating for the faults by manipulating the data storage under control of the plurality of storage management processes without affecting accessibility of the data storage.

44. A method of data storage management comprising the acts of:
providing a plurality of network-accessible storage devices each capable of storing data;
implementing a plurality of storage management process instances; and
communicating storage messages between the storage management process instances, wherein any of the storage management process instances is capable of storage allocation and deallocation across the plurality of storage nodes;

45. The method of claim 44 wherein the storage allocation management processes are configured to use the storage messages to reconstruct data stored in a failed one of the storage devices.

46. The method of claim 44 wherein the storage management processes are configured to migrate data amongst the storage devices using the storage messages in response to a detected fault condition in at least one fo the storage devices.

47. The method of claim 44 wherein the storage management processes are configured to migrate data amongst the storage devices using the storage messages in preemptively when a fault condition in at least one of the storage devices is determined to be likely.

48. The method of claim 44 wherein the plurality of storage devices comprises an arbitrarily large number of storage devices.

50. The method of claim 44 further comprising:
associating parity information with a data set;
storing the parity information in at least some of the storage devices; and
serving data requests corresponding to the data set by accessing the parity information associated with the data set.

51. The method of claim 44 further comprising:
storing a data set in a plurality of the data storage devices using the storage management processes;
serving data requests corresponding to the data set by accessing the plurality of data storage devices in parallel.

52. The method of claim 44 further comprising encrypting storage messages before communicating.
